(19) United States
(12) Patent Application Publication
(10) Pub. No.: US 2021/0206649 A1
(43) Pub. Date: Jul. 8, 2021

(54) SEALING MATERIAL

(71) Applicant: NICHIAS CORPORATION, Tokyo (JP)

(72) Inventors: Katsutoyo ITOI, Tokyo (JP); Makoto YAMANAKA, Tokyo (JP)

(73) Assignee: NICHIAS CORPORATION, Tokyo (JP)

(21) Appl. No.: 16/760,059

(22) PCT Filed: Oct. 26, 2018
(86) PCT No.: PCT/JP2018/039875

§ 371 Date: Apr. 29, 2020

(30) Foreign Application Priority Data
Oct. 31, 2017 (JP) 2017-211081

(51) Int. Cl. C01B 33/42; C04B 33/04; C04B 33/13; F16J 15/10

(52) U.S. Cl. CPC C01B 33/425; C04B 33/04; C04B 33/1305; F16J 15/10; C04B 2235/5292; C01P 2006/10; C04B 2235/3445; C04B 2235/77; C01P 2004/24

(57) ABSTRACT

A sealing material including a water-resistant sheet, wherein the water-resistant sheet includes layered clay minerals having a thickness of 0.5 nm to 800 nm. A sealing material including a sheet, wherein the sheet includes modified layered clay minerals in which at least a portion of a first cation between the interlayer of swellable layered clay minerals is ion-exchanged with a second cation, in a first cation being one or more selected from Na⁺ and Li⁺. A sealing material including a sheet, wherein the sheet includes layered clay minerals having a thickness of 0.5 nm to 800 nm, and having one or more selected from K⁺, Ba²⁺ and Pb²⁺ are contained in at least a portion in an interlayer of the clay minerals.

### TECHNICAL FIELD

The present invention relates to a sealing material such as a gasket or a packing.

### BACKGROUND ART

Sealing materials such as gaskets and packings are used for piping flanges and the like in various industries. As a gasket, a sheet gasket, a spiral gasket, a sawtooth gasket, and the like are known.

A spiral gasket is obtained by winding a hoop material and a filler material in a stacked state. In a sawtooth gasket, generally, a number of concentric circular grooves having different diameters are formed on both surfaces of a metal main body at almost equal pitches in the radial direction, and the cross section has a sawtooth shape.

Patent Document 1 discloses a spiral gasket in which expanded graphite is used as a filler material. A sealing material formed of expanded graphite has sufficient elasticity and is excellent in heat resistance. However, as for expanded graphite, in a temperature range exceeding 500° C. in the presence of oxygen, disappearance of expanded graphite by oxidation is promoted. Therefore, it was difficult to maintain stable sealing property for a long period of time. Patent Document 2 discloses a spiral gasket in which unexfoliated mica and expanded graphite are used as a filler material. However, in this spiral gasket, expanded graphite disappears when used at high temperatures, and hence, sealing property cannot be maintained. Patent Document 3 discloses a spiral gasket in which unexfoliated mica is used as a filler material. Only a sheet having a high density could be obtained, and this gasket was poor in sealing property. Patent Document 4 discloses a gasket in which an exfoliated-layered clay mineral having a high sealing property is used.

Patent Document 5 discloses that the interlayer ion of swelling fluorine mica is exchanged with another cation to increase the mechanical strength of the sheet obtained from thus modified synthetic fluorine mica.

### RELATED ART DOCUMENT

### Patent Document

[Patent Document 1] JP 3163562 B2
[Patent Document 2] JP 3310619 B2
[Patent Document 3] JP 5047490 B2
[Patent Document 4] WO 2016/125486 A1
[Patent Document 5] JP H05-262514 A

### SUMMARY OF THE INVENTION

The sealing material of Patent Document 4 has low water resistance and cannot be used for a fluid such as water.

It is an object of the present invention to provide a sealing material having excellent water resistance.

The present inventors have found that a sealing material having excellent water resistance can be obtained by using layered clay minerals in which Na ion between layers of the layered clay minerals is exchanged with K ion or the like, and have completed the present invention.

According to the present invention, the following sealing material is provided.

1. A sealing material comprising a water-resistant sheet, wherein the water-resistant sheet comprises layered clay minerals having a thickness of 0.5 nm to 1000 nm.
2. A sealing material comprising a sheet, wherein the sheet comprises modified layered clay minerals in which at least a portion of a first cation between the interlayer of swellable layered clay minerals is ion-exchanged with a second cation, in a first cation being one or more selected from Na⁺ and Li⁺.
3. A sealing material comprising a sheet, wherein the sheet comprises layered clay minerals having a thickness of 0.5 nm to 1000 nm, and having one or more selected from K*, Ba²⁺ and Pb²⁺ are contained in at least a portion in an interlayer of the clay minerals.
4. The sealing material according to 2, wherein the thickness of the layered clay minerals is 0.5 nm to 1000 nm.
5. The sealing material according to any one of 1 to 4, wherein the layered clay mineral is a natural clay or a synthetic clay.
6. The sealing material according to 5, wherein the natural clay or the synthetic clay is mica, vermiculite, montmorillonite, iron montmorillonite, beidellite, saponite, hectorite, stevensite, or nontronite.
7. The sealing material according to 6, wherein the mica is fluorine mica.
8. The sealing material according to 7, wherein the fluorine mica is represented by the following formula:

αMF·βLF·γ(aMgF₂·bMgO)·δSiO₂
wherein M is an interlayer ion and represents one or more selected from K⁺, Ba²⁺ and Pb²⁺,
L is an interlayer ion and represents Na⁺ or Li⁺,
0<α≤2,
0≤β<2,
α+β is 0.1 to 2,
γ represents 2 to 3.5,
δ represents 3 to 4,
a and b represent 0 to 1 respectively and
a+b=1.
   9. The sealing material according to any one of 1 to 8, wherein a porosity of the sheet when compressed at a surface pressure of 34 MPa is 40% or less.
   10. The sealing material according to any one of 1 to 9, wherein the sheet comprises an organic binder.
   11. The sealing material according to 10, wherein the organic binder is one or more selected from acrylonitrile butadiene rubber, styrene butadiene rubber, polybutadiene rubber, silicone rubber, acrylic rubber, natural rubber, butyl rubber, chloroprene rubber, ethylene propylene rubber, fluorine rubber, urethane rubber, acrylic adhesive, and silicone adhesive.
   12. The sealing material according to any one of 1 to 11, wherein a density of the sheet exceeds 1.6 g/cm³.

According to the present invention, a sealing material having excellent water resistance can be provided.

### BRIEF DESCRIPTION OF THE DRAWINGS

FIG. 1 is a schematic cross-sectional view of a spiral gasket according to a first embodiment of the present invention.

FIG. 2 is a schematic cross-sectional view of a sawtooth gasket according to the second embodiment of the present invention.

FIG. 3 is a schematic cross-sectional view of a spiral gasket according to the third embodiment of the present invention.

### MODE FOR CARRYING OUT THE INVENTION

The sheet used in the sealing material of the present invention comprises an aggregate of layered clay minerals.

As the layered clay minerals used in the present invention, for example, layered clay minerals, in which an element ion exhibiting non-swelling property (generally, cations other than Li⁺ and Na⁺ exhibit non-swelling property) and organic cation are present in at least partially between the layers, can be used. Examples of the organic cation include ammonium ions (primary to quaternary ammonium ions). Preferably, a layered clay mineral can be used in which at least one or more selected from K⁺, Ba²⁺ and Pb²⁺, more preferably K⁺, are present in at least partially between the layers.

The clay mineral may be a natural clay mineral or a synthetic clay mineral, and its examples include mica, vermiculite, montmorillonite, iron montmorillonite, beidellite, saponite, hectorite, stevensite, and nontronite.

Specifically, as the layered clay minerals, fluorine mica represented by the following formula can be used.

αMF·βLF·γ(aMgF₂·bMgO)·δSiO₂,

wherein in the formula, M is an interlayer ion and represents one or more selected from K⁺, Ba²⁺ and Pb²⁺,

L is an interlayer ion and represents Na⁺ or Li⁺,

α and β are 0<α≤2, 0≤β<2,

α+β is 0.1 to 2,

γ represents 2 to 3.5,

δ represents 3 to 4, and

a and b represent 0 to 1, respectively, and a+b=1.

As the layered clay mineral used in the present invention, for example, a modified layered clay mineral, in which at least a portion of a first cation which is an interlayer ion of a swellable layered clay mineral is ion-exchanged with a second cation, can be used. Ion exchange of a swellable layered clay mineral reduces swellability. The exchange rate depends on the type of anion, and is usually 20% or more. That is, 20% or more of the interlayer ions are the second cations.

Fluorine mica of the above formula can be exemplified as the modified layered clay mineral. In this case, the first ion is L and the second ion is M.

In the present invention, the water resistance of the obtained sheet is improved by using the modified layered clay mineral. The sheet of the present invention preferably has a water resistance capable of maintaining the shape of the sheet in the water resistance test measured by the method described in the Examples.

As the layered clay minerals, an exfoliated body from which the clay minerals are exfoliated can be used. This exfoliated body may be a single layer, and is usually an exfoliated body in which a plurality of layers is laminated. Such layered clay minerals (exfoliated bodies) are usually flaky and have a thickness of 0.5 nm to 1000 nm. For example, the thickness may be between 1 nm and 800 nm, between 3 nm and 500 nm, between 5 nm and 100 nm, or between 10 nm and 50 nm. The thinner the thickness is, the better the sealing property is. Thickness can be measured by the methods described in the Examples.

The exfoliated degree of the exfoliated body strongly correlates with the thickness of the layered body or the bulk density of the layered body, and the smaller the bulk density is, the thinner the peeled laminate exfoliated layered body is.

The density of the sheet of the present invention is preferably 0.5 to 2.5 g/cm³, more preferably 1.0 to 2.0 g/cm³, and still more preferably 1.2 to 1.8 g/cm³. The sheet having a density exceeding 1.6 g/cm³ can be used in the present invention.

The sheet of the present invention preferably has a porosity of 40% or less, more preferably 35% or less, still more preferably 30% or less, and particularly preferably 25% or less, when compressed at a surface pressure of 34 MPa. The lower limit is not restricted, but is normally 1% or more. When the porosity is small, the sealing property is improved. The porosity can be adjusted by the thickness or the like of one piece of the layered clay mineral. The porosity can be measured by the method described in the Examples.

The sealing property of the sheet at the normal temperature is preferably 70 mL/min or less, more preferably 50 mL/min or less, still more preferably 30 mL/min or less, and particularly preferably 20 mL/min or less, as measured by the method described in the Examples.

The sheet may contain binders and the like in addition to the layered clay minerals, provided that the advantageous effects of the present invention are not impaired. The sheet can be composed of 90% or more by weight, 95% or more by weight, 98% or more by weight, or 100% by weight of layered clay minerals. Further, the sheet can be composed of 90% or more by weight, 95% or more by weight, 98% or more by weight, or 100% by weight of layered clay minerals and binders.

As the binder, rubbers, adhesives or the like can be exemplified. The preferred binder includes an acrylonitrile butadiene rubber, a styrene butadiene rubber, a polybutadiene rubber, a silicone rubber, an acrylic rubber, a natural rubber, a butyl rubber, a chloroprene rubber, an ethylene propylene rubber, a fluororubber, a urethane rubber, an acrylic adhesive or a silicone adhesive. The binder is preferably an acrylonitrile butadiene rubber or a silicone rubber. By including the binder, the obtained sheet can be provided with flexibility.

The amount of binder is preferably from 0.3 to 20% by weight of the sheet. If it is less than 0.3% by weight, the flexibility may become insufficient, and if it is more than 20% by weight, the characteristics such as the sealing property may be impaired. The amount of binder is more preferably 0.5 to 15% by weight, more preferably 1 to 10% by weight.

A sheet of the modified layered clay mineral can be produced, for example, by the following method.

The swellable layered clay mineral is placed in an aqueous solution containing a cation (a hydroxide solution, a chloride solution, etc.) and stirred. The swellable layer clay mineral is swelled. The cation between the layers is exchanged with the cation of the aqueous solution. The modified layered clay mineral is dehydrated and put into a mold, and compression molding is performed to an arbitrary thickness to obtain a sheet having an arbitrary density and size.

When an ion exchange is performed, a first cation may be exchanged first, and then at least a portion of the first cation may be exchanged with a second cation.

The thickness of the resulting sheet is usually about 0.1 to 10 mm.

The sheet can be used for sealing materials of various types of piping such as exhaust pipes of various industries and automobiles, for example, gaskets, packings, and the like. The sheet can be used as the sealing material itself or as a portion of the sealing material.

Next, an embodiment in which the sealing material of the present invention is a gasket will be described.

One aspect of the gasket of the present invention is that one or both sides of the gasket body is covered with sheets of layered clay minerals.

Examples of the gasket include a spiral gasket provided with a spiral gasket main body obtained by winding a hoop material and a filler material spirally in a stacked state, a sawtooth gasket provided with a sawtooth gasket main body in which grooves having a sawtooth-shaped cross section are formed on one surface or both surfaces of the main body, and the like.

Another aspect of the gasket of the present invention is that a sheet containing layered clay minerals is used as a filler material in a spiral gasket main body in which a hoop material and a filler material are spirally wound in a stacked state.

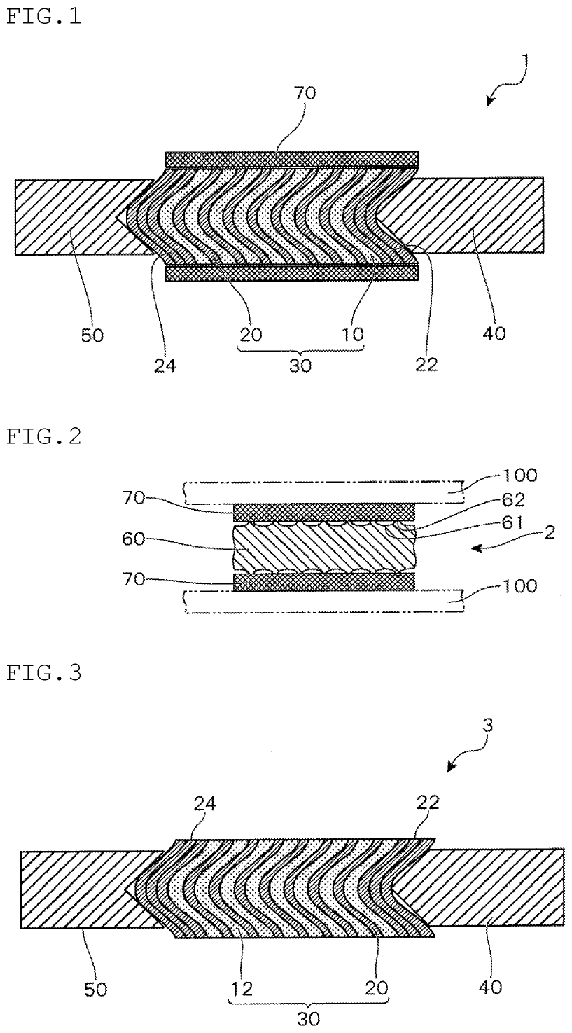

FIG. 1 is a schematic cross-sectional view of a spiral gasket according to the first embodiment of the present invention. As shown in FIG. 1, a spiral gasket 1 has a structure in which a spiral gasket main body 30 is held between an outer ring 50 and an inner ring 40, and in which the spiral gasket main body 30 is formed by spirally winding a hoop material 20 and a filler material 10 in a stacked state. The spiral gasket main body 30 has a sheet 70 of layered clay minerals laminated on both sides of its annular surface (its exposed surface). Preferably, the inner circumferential wound hoop portion 22 in which only the hoop material 20 is wound is formed on the inner circumference of the gasket main body portion 30. In addition, preferably, an outer circumferential wound hoop portion 24 in which only the hoop material 20 is wound is formed on the outer circumference of the gasket main body portion 30.

The spiral gasket according to this embodiment may be provided with the inner ring 40 and the outer ring 50 as shown in FIG. 1, and may be provided with only the outer ring 50 or only the inner ring 40. The sheet 70 covers both annular surfaces of the gasket body 30, and may cover only one surface. Further, in FIG. 1, the sheet 70 covers the entire annular surface of the gasket body 30, and may cover a portion of the gasket body 30.

In the spiral gasket 1, since the surface of the gasket main body 30 is covered with the sheet 70, it is possible to improve the familiarity with the joints (flanges) and the like of various pipes, reduce leakage from the contact surface, and prevent burnout of the filler material, thereby improving the sealing property of the gasket itself.

The covering method for covering the surface of the gasket main body with a sheet is not particularly limited, and can be carried out by using an adhesive such as glue, for example. Instead of using the adhesion, placing the sheet formed of flaky clay minerals on the exposed surface may suffice.

FIG. 2 is a schematic cross-sectional view of a sawtooth gasket 2 according to the second embodiment of the present invention installed on flanges 100.

As shown in FIG. 2, the sawtooth gasket 2 has sheet 70 layered on both sides of its annular surface of the sawtooth gasket main body 60. In the sawtooth gasket main body 60, plural concentric grooves 61 differing in diameter are formed. That is, as shown in FIG. 2, grooves 61 are formed between adjacent teeth 62.

The sawtooth gasket 2 is tightened so that the sheet 70 flows into the groove portion formed between the sawteeth and demonstrates excellent sealing property even at low surface pressure. Further, since the sheet is adhered onto the surface, the familiarity with the flange surface is excellent. In addition, the front end of the sawtooth does not directly contact the flange, and the flange surface is not damaged.

As in the case of the spiral gasket, an outer ring and/or an inner ring (not shown) may be attached to the sawtooth gasket 2.

FIG. 3 is a schematic cross-sectional view of a spiral gasket according to the third embodiment of the present invention.

The spiral gasket of the embodiment differs from the spiral gasket of FIG. 1 in that the filler material comprises a layered clay mineral and in that the filler material does not need to be covered with sheets. The same members as those of the first embodiment are denoted by the same reference numerals, and descriptions thereof are omitted.

The filler material 12 used in the spiral gasket 3 is a tape-like or a plurality of strip-like sheets containing a layered clay mineral. This sheet is the same as sheet 70 of the first embodiment, but is typically 0.05 to 1.0 mm thick because it is used as a filler material.

### EXAMPLES

### Example 1

As clays, 10 g of swellable mica “DMA-350” (manufactured by TOPY INDUSTRIES, LIMITED) which is sodium-tetrasilicon mica was added to 90 g of distilled water and stirred with a glass rod. Next, 500 mL of 5 N potassium hydroxide was added thereto and stirred to obtain a uniform clay-dispersed liquid. The resulting clay-dispersed liquid was frozen by using liquid nitrogen. The ice was frozen-dried by using a freeze dryer “FDU-2110” (manufactured by Tokyo Rika Kiki Co., Ltd.), to obtain an exfoliated body of mica. 2.5 g of the exfoliated body of mica was put into a mold (having a diameter of 65 mm and having a cylindrical depression), and compression molded using a cylindrical rod to obtain a 0.4 mm sheet.

The obtained sheet was subjected to the following evaluation. The results are shown in Table 1.

### (1) Water Resistance

The sheet was immersed in 80° C. water for 24 hours. Whether the sheet shape was maintained after immersion was visually judged.

When the shape was maintained, it was evaluated as “∘,” and when the shape was not maintained, it was evaluated as “x.”

### (2) Thickness of the Layered Clay Mineral

Determined by Williamson-Hall method.

### (3) Porosity

A 30 mm diameter sample was punched out of the sheet and weighed. Next, the punched out sample was compressed at a surface pressure of 34 MPa, and the thickness at that time was measured, and the volume at the time of compression was obtained from the sample size. The density at the time of compression was calculated from the weight of the sample and the volume at the time of compression.

The true densities of the sheets were measured according to JISR1620.

The porosity was calculated from the density at the time of compression and the true density by the following equation.

Porosity (%)=100−Density at compression/True density×100

### (4) Sealability (Normal Temperature)

The flanges were measured in the same manner as in Evaluation Example 2 of Patent Document 4, except that the flanges were changed to JIS10K20ARF and the clamping surface pressure was changed to 34 MPa.

### (5) Sealability (High Temperature)

The measurement was performed in the same manner as in Evaluation Example 2 of Patent Document 4 except that the heating cycle condition was changed to 650° C.×10 hours of heating.

### (6) Ion-Exchange Property

Interlayer ions of mica were examined by X-ray fluorescence. As a result, about 30% of Na⁺ of interlayer ions of mica was exchanged into K⁺.

### Example 2

As clays, 2 g of swellable mica “DMA-350” was added to 98 g of distilled water and stirred with a glass rod. Next, 500 mL of 5 N potassium hydroxide and 0.2 g of latex “NipolLX513” (rubber content: 45%) (Zeon Corporation) were added to obtain uniform dispersions. Thereafter, a sheet was produced and evaluated in the same manner as in Example 1.

### Example 3

As clays, 5 g of swellable mica “DMA-350” was added to 95 g of distilled water and stirred with a glass rod. Next, 500 mL of 5 N potassium hydroxide and 0.5 g of latex “NipolLX513” were added to obtain uniform dispersions. Thereafter, a sheet was produced and evaluated in the same manner as in Example 1.

### Example 4

As a clay, 10 g of swellable mica “DMA-350” was added to 90 g of distilled water and stirred with a glass rod. Next, 500 mL of 5 N potassium hydroxide and 1.0 g of latex “NipolLX513” were added to obtain uniform dispersions. Thereafter, a sheet was produced and evaluated in the same manner as in Example 1.

### Example 5

As a clay, 20 g of swellable mica “DMA-350” was added to 80 g of distilled water and stirred with a glass rod. Next, 500 mL of 5 N potassium hydroxide and 2.2 g of latex “NipolLX513” were added to obtain uniform dispersions. Thereafter, a sheet was produced and evaluated in the same manner as in Example 1.

### Example 6

As a clay, 30 g of swellable mica “DMA-350” was added to 70 g of distilled water and stirred with a glass rod. Next, 500 mL of 5 N potassium hydroxide and 3.8 g of latex “NipolLX513” were added to obtain uniform dispersions. Thereafter, a sheet was produced and evaluated in the same manner as in Example 1.

### Example 7

As a clay, 40 g of swellable mica “DMA-350” was added to 60 g of distilled water and stirred with a glass rod. Next, 500 mL of 5 N potassium hydroxide and 3.8 g of latex “NipolLX513” were added to obtain uniform dispersions. Thereafter, a sheet was produced and evaluated in the same manner as in Example 1.

### Example 8

As clays, 50 g of swellable mica “DMA-350” was added to 50 g of distilled water and stirred with a glass rod. Next, 500 mL of 5 N potassium hydroxide and 3.8 g of latex “NipolLX513” were added to obtain uniform dispersions. Thereafter, a sheet was produced and evaluated in the same manner as in Example 1.

### Example 9

As a clay, 10 g of swellable mica “DMA-350” was added to 90 g of distilled water and stirred with a glass rod. Next, 500 mL of 5 N potassium hydroxide and 1.2 g of latex “NipolLX513” were added to obtain uniform dispersions. Thereafter, a sheet was produced and evaluated in the same manner as in Example 1.

### Example 10

As a clay, 10 g of swellable mica “DMA-350” was added to 90 g of distilled water and stirred with a glass rod. Next, 500 mL of 5 N potassium hydroxide and 2.0 g of latex “NipolLX513” were added to prepare obtain uniform dispersions. Thereafter, a sheet was produced and evaluated in the same manner as in Example 1.

### Example 11

As a clay, 10 g of swellable mica “DMA-350” was added to 90 g of distilled water and stirred with a glass rod. Next, 500 mL of 5 N potassium hydroxide and 2.5 g of latex “NipolLX513” were added to obtain uniform dispersions. Thereafter, a sheet was produced and evaluated in the same manner as in Example 1.

### Comparative Example 1

As clays, 50 g of gold mica “SUZORITEMICA200S” (non-swellable mica) (Imerys Performance Minerals North America) was added to 50 g of distilled water and stirred with a glass rod. Next, 1.0 g of latex “NipolLX513” was added to obtain uniform dispersions. Thereafter, a sheet was produced and evaluated in the same manner as in Example 1.

### Comparative Example 2

As a clay, 10 g of swellable mica “DMA-350” was added to 90 g of distilled water and stirred with a glass rod. Next, latex 1.0 g of latex “NipolLX513” was added to obtain uniform dispersions. Thereafter, a sheet was produced and evaluated in the same manner as in Example 1.

TABLE 1

| | | Examples | | | | | | | | | | | Comparative Examples | |
|---|---|---|---|---|---|---|---|---|---|---|---|---|---|---|
| | | 1 | 2 | 3 | 4 | 5 | 6 | 7 | 8 | 9 | 10 | 11 | 1 | 2 |
| Thickness of flaky clay minerals (nm) | | 21 | 16 | 17 | 21 | 23 | 26 | 41 | 86 | 21 | 21 | 21 | 1000 | 26 |
| Amount of binder (wt %) | | 0 | 4 | 4 | 4 | 4 | 4 | 4 | 4 | 5 | 8 | 10 | 4 | 4 |
| Water resistance | | ◯ | ◯ | ◯ | ◯ | ◯ | ◯ | ◯ | ◯ | ◯ | ◯ | ◯ | ◯ | X |
| Density (g/cm3) | | 1.7 | 1.7 | 1.7 | 1.7 | 1.7 | 1.7 | 1.6 | 1.6 | 1.7 | 1.7 | 1.8 | 1.6 | 1.7 |
| Porosity (at a surface pressure of 34 MPa) | | 5 | 3 | 4 | 5 | 6 | 10 | 17 | 28 | 5 | 6 | 6 | | 10 |
| Sealability (ml/min) | Normal Temperature | 0.1 | 0.0 | 0.0 | 0.1 | 0.2 | 0.6 | 2 | 7 | 0.0 | 0.0 | 0.0 | >100 | 0.5 |
| | High Temperature | 0.1 | 0 | 0 | 0.1 | 0.2 | 0.7 | 2 | 8 | 0.1 | 0.2 | 1 | — | 0.8 |
| | (650° C.) | | | | | | | | | | | | | |

### INDUSTRIAL APPLICABILITY

The sealing material of the present invention can be used for sealing a fluid such as water, oil, steam, gas or the like in equipment in a high-temperature and high-pressure state, a joint portion of various pipes or the like in a petroleum refinery, a petrochemical plant, an LNG plant, a power plant, an iron mill, or the like.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents stated in the description and the specification of Japanese applications on the basis of which the present application claims Paris Convention priority is incorporated herein by reference in its entirety.

1. A sealing material comprising a water-resistant sheet, wherein the water-resistant sheet comprises layered clay minerals having a thickness of 0.5 nm to 800 nm.

2. A sealing material comprising a sheet, wherein the sheet comprises modified layered clay minerals in which at least a portion of a first cation between the interlayer of swellable layered clay minerals is ion-exchanged with a second cation, in a first cation being one or more selected from Na⁺ and Li⁺.

3. A sealing material comprising a sheet, wherein the sheet comprises layered clay minerals having a thickness of 0.5 nm to 800 nm, and having one or more selected from K⁺, Ba²⁺ and Pb²⁺ are contained in at least a portion in an interlayer of the clay minerals.

4. The sealing material according to claim 2, wherein the thickness of the layered clay minerals is 0.5 nm to 1000 nm.

5. The sealing material according to claim 1, wherein the layered clay mineral is a natural clay or a synthetic clay.

6. The sealing material according to claim 5, wherein the natural clay or the synthetic clay is mica, vermiculite, montmorillonite, iron montmorillonite, beidellite, saponite, hectorite, stevensite, or nontronite.

7. The sealing material according to claim 6, wherein the mica is fluorine mica.

8. The sealing material according to claim 7, wherein the fluorine mica is represented by the following formula:
αMF·βLF·γ(aMgF₂·bMgO)·δSiO₂
wherein M is an interlayer ion and represents one or more selected from K⁺, Ba²⁺ and Pb²⁺,
L is an interlayer ion and represents Na⁺ or Li⁺,
0<α≤2,
0≤β<2,
α+β is 0.1 to 2,
γ represents 2 to 3.5,
δ represents 3 to 4,
a and b represent 0 to 1 respectively and
a+b=1.

9. The sealing material according to claim 1, wherein a porosity of the sheet when compressed at a surface pressure of 34 MPa is 40% or less.

10. The sealing material according to claim 1, wherein the sheet comprises an organic binder.

11. The sealing material according to claim 10, wherein the organic binder is one or more selected from acrylonitrile butadiene rubber, styrene butadiene rubber, polybutadiene rubber, silicone rubber, acrylic rubber, natural rubber, butyl rubber, chloroprene rubber, ethylene propylene rubber, fluorine rubber, urethane rubber, acrylic adhesive, and silicone adhesive.

12. The sealing material according to claim 1, wherein a density of the sheet exceeds 1.6 g/cm³.
